(19) United States
(12) Patent Application Publication
(10) Pub. No.: US 2016/0335236 A1
(43) Pub. Date: Nov. 17, 2016

(54) Network Platform For Annotating Recorded Medical Information

(71) Applicant: Physio-Control, Inc., Redmond, WA (US)

(72) Inventors: Brian D. Webster, Sammamish, WA (US); Traci S. Umberger, Bellevue, WA (US); Fred W. Chapman, Newcastle, WA (US); Steven B. Duke, Edmonds, WA (US)

(21) Appl. No.: 15/156,279

(22) Filed: May 16, 2016

Related U.S. Application Data
(60) Provisional application No. 62/162,616, filed on May 15, 2015.

(51) Int. Cl. G06F 17/24; G06F 19/00; H04L 29/08

(52) U.S. Cl. CPC G06F 17/241; H04L 67/125; G06F 19/325

(57) ABSTRACT

Disclosed is an annotator network platform. Specific embodiments enable one or more customers to request an annotation of an incident report. A platform host assigns the incident report to one or more available annotators who provide an annotation service on the incident report to generate an annotated incident report. The annotated incident report is returned to the requesting customer.

### CROSS REFERENCE TO RELATED APPLICATIONS

This patent application claims the benefit of and priority to U.S. Provisional Patent Application Ser. No. 62/162,616 filed on May 15, entitled “Method and System for Annotating Recorded Medical Information,” the disclosure of which is hereby incorporated by reference for all purposes.

### TECHNICAL FIELD

The disclosed subject matter pertains generally to the area of medical devices, and more specifically to the area of providing remote annotation services for medical care providers.

### BACKGROUND INFORMATION

Health care providers often use portable medical devices to facilitate the provision of health care services as early as possible. Cardiac emergencies, such as sudden cardiac arrest (SCA), occur with some frequency and require prompt and effective treatment. For a patient suffering from such conditions, delayed or poor medical treatment commonly results in death of the patient. Early treatment for such cardiac incidents often includes some form of cardiopulmonary resuscitation (CPR). Reestablishing blood flow in a patient suffering from SCA is often the most critical element of successful early treatment. Medical devices have been developed to perform chest compressions on a patient, freeing medical personnel to perform other tasks.

For most medical emergencies, including SCA, medical treatment should be both prompt and proper to maximize the patient's chance of survival. Almost any assistance is better than no assistance. But the better the treatment, the better the patient's chance at survival. Accordingly, protocols for effective treatment have been developed. From time to time, those protocols are reviewed and revised with an eye toward improving them based on historical effectiveness.

Improvements to techniques for performing rapid medical treatments are a constant goal of the medical community. To that end, evaluating the effectiveness of treatments that have been performed is a beneficial component of refining and improving those treatments. In addition, evaluating treatments that are actually performed against established protocols helps to improve training of medical personnel.

### SUMMARY OF EMBODIMENTS

Embodiments are directed to an annotator network platform. Specific implementations enable one or more customers to request an annotation of an incident report. A platform host assigns the incident report to one or more available annotators who provide an annotation service on the incident report to generate an annotated incident report. The annotated incident report is returned to the requesting customer.

Embodiments implement a network of annotators, a network of customers, and a platform host that manages transactions between customers and annotators. The platform host receives an annotation request for an annotation from a customer. The platform host identifies an appropriate annotator from a listing of available annotators. The platform host assigns the annotation request to the appropriate annotator. Once annotation is complete, the platform host returns an annotated incident report to the customer.

Specific embodiments implement compensation mechanisms for tracking and executing compensation of annotators. Compensation may be made in either monetary or non-monetary form.

The platform host may alternatively be implemented as a distributed system of locally-executing software components or as a centralized service available remotely over a wide area network, such as the Internet.

These and other embodiments will become apparent to those skilled in the art after a close review and study of the following disclosure and teachings.

### BRIEF DESCRIPTION OF THE DRAWINGS

FIG. 1 is a diagram of a scene where an external defibrillator is used to try and save the life of a person in accordance with an embodiment.

FIG. 2 is a table listing two main types of the external defibrillator shown in FIG. 1, and by whom they might be used.

FIG. 3 is a diagram showing components of an external defibrillator made according to embodiments.

FIG. 4 is a functional block diagram generally illustrating an annotator network platform in accordance with one embodiment.

FIG. 5 is a logical flow diagram generally illustrating operations performed by a process for generating annotated incident reports, in accordance with one embodiment.

FIG. 6 is a functional block diagram generally illustrating the annotation of an incident report, in accordance with one embodiment.

FIG. 7 is a functional block diagram generally illustrating one specific implementation of a platform host that may be used in various embodiments.

### DETAILED DESCRIPTION

Generally described, the disclosure is directed to an annotator network platform to provide annotation of treatment data collected after a medical incident. Specific embodiments and implementations are described below.

Currently, existing software, such as the CODE-STAT™ Data Review Software (“Code-Stat”) product available from Physio-Control, Inc., allows customers to annotate incident reports for event review. These annotated incident reports can be used to establish a baseline of emergency care performance, and to provide feedback for performance during particular events. The disclosed embodiments teach an annotator platform used to (a) provide “raw” incident reports to annotators; (b) return the annotated incident reports back to customers; (c) administer billing of the customers; (d) administer payment to the annotators; and (e) tracking/reporting of the assignments, payments, billings, and annotator performance metrics.

Description of Operative Environment for Embodiments

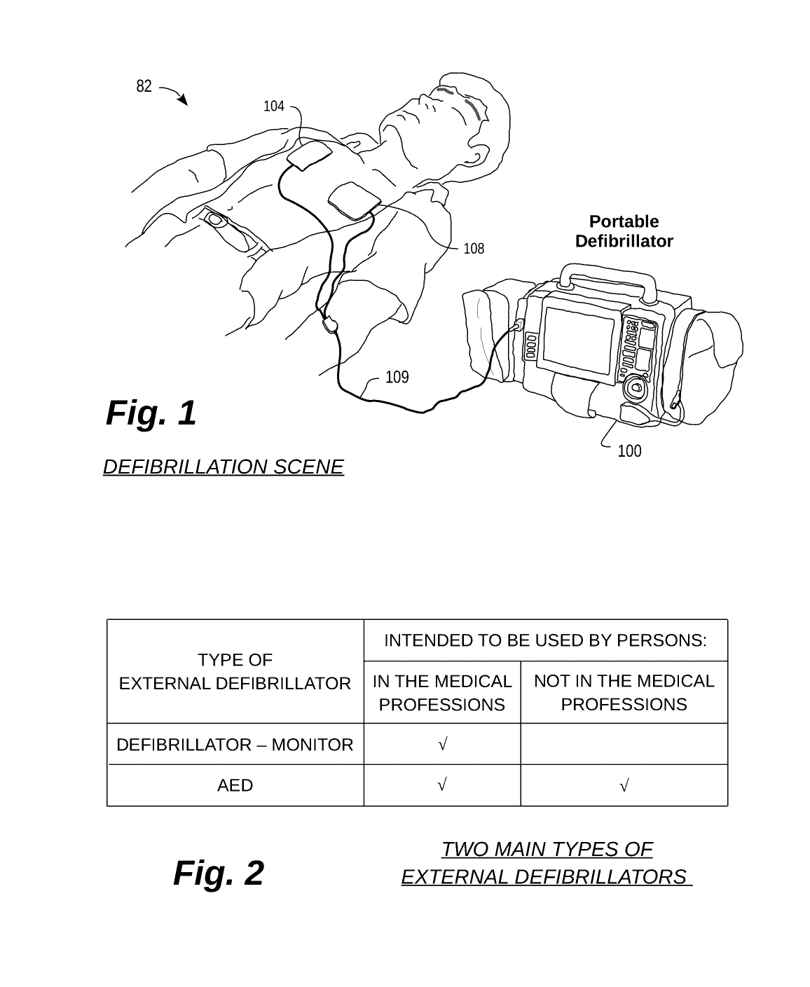

FIG. 1 is an illustration of a defibrillation scene. A person 82 is lying supine. Person 82 could be a patient in a hospital or someone found unconscious. Person 82 is experiencing a medical emergency, which could be, by way of an example, Ventricular Fibrillation (VF).

A portable external defibrillator 100 has been brought close to person 82. The portable external defibrillator can also be a hybrid monitor/defibrillator 82. At least two defibrillation electrodes 104, 108 are usually provided with external defibrillator 100. Electrodes 104, 108 are coupled with external defibrillator 100 via electrode leads 109. A rescuer (not shown) has attached electrodes 104, 108 to the skin of person 82. Defibrillator 100 is monitoring cardiac rhythms and potentially administering, via electrodes 104, 108, a brief, strong electric pulse through the body of person 82. The pulse, also known as a defibrillation shock, goes through the person's heart in an attempt to restart it, for saving the life of person 82.

Defibrillator 100 can be one of different types, each with different sets of features and capabilities. The set of capabilities of defibrillator 100 is determined by planning who would use it, and what training they would be likely to have. Examples are now described.

FIG. 2 is a table listing examples of types of external defibrillators and their primary intended users. A first type of defibrillator 100 is generally called a defibrillator-monitor (or monitor-defibrillator) because it is typically formed as a single unit in combination with a patient monitor. Alternatively, the defibrillator-monitor may be a modular device with separable components. For example, in one alternative embodiment, the defibrillator-monitor may include a base component and a plurality of detachable pods. Each pod communicates with the base component, perhaps wirelessly. Certain pods may be used to collect information about a patient, such as vital statistics. One example of such an alternative system is described in U.S. Pat. No. 8,738,128 entitled “Defibrillator/Monitor System Having A Pod With Leads Capable Of Wirelessly Communicating,” the disclosure of which is hereby incorporated by reference for all purposes. A defibrillator-monitor is intended to be used by medical professionals, such as doctors, nurses, paramedics, emergency medical technicians, etc. Such a defibrillator-monitor is generally intended to be used in a pre-hospital or hospital scenario.

As a defibrillator, the device can be one of different varieties, or even versatile enough to be able to switch among different modes that individually correspond to the varieties. One variety is that of an automated defibrillator, which can determine whether a shock is needed and, if so, charge to a predetermined energy level and instruct the user to administer the shock. Another variety is that of a manual defibrillator, where the user determines the need and controls administering the shock.

As a patient monitor, the device has features additional to what is minimally needed for mere operation as a defibrillator. These features can be for monitoring physiological indicators of a person in an emergency scenario. These physiological indicators are typically monitored as signals, such as a person's full ECG (electrocardiogram) signals, or impedance between two electrodes. Additionally, these signals can be about the person's temperature, non-invasive blood pressure (NIBP), arterial oxygen saturation/pulse oximetry (SpO2), the concentration or partial pressure of carbon dioxide in the respiratory gases, which is also known as capnography, and so on. These signals can be further stored and/or transmitted as patient data.

A second type of external defibrillator 100 is generally called an AED, which stands for “Automated External Defibrillator.” An AED typically makes the shock/no shock determination by itself, automatically. It can typically sense enough physiological conditions of the person 82 using only the defibrillation electrodes 104, 108 shown in FIG. 1. An AED can either administer the shock automatically, or instruct the user to do so, e.g. by pushing a button.

There are other types of external defibrillators in addition to those listed in FIG. 2. For example, a hybrid defibrillator can have aspects of an AED and also of a defibrillator-monitor. A usual such aspect is additional ECG monitoring capability.

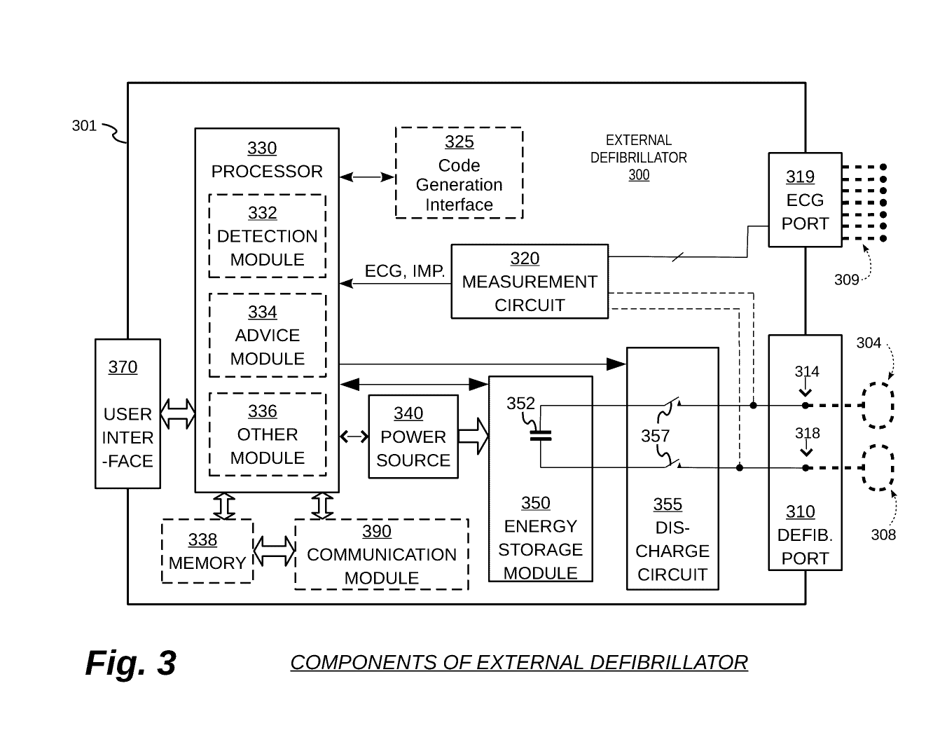

FIG. 3 is a diagram showing components of an external defibrillator 300 made according to embodiments. These components can be, for example, in external defibrillator 100 of FIG. 1. Plus, the components shown in FIG. 3 can be provided in a housing 301, also known as a casing.

External defibrillator 300 is intended for use by a user, who would be the rescuer. Defibrillator 300 typically includes a defibrillation port 310, such as a socket in housing 301. Defibrillation port 310 includes nodes 314, 318. Defibrillation electrodes 304, 308, which can be similar to electrodes 104, 108, can be plugged in defibrillation port 310, so as to make electrical contact with nodes 314, 318, respectively. It is also possible that electrodes can be connected continuously to defibrillation port 310, etc. Either way, defibrillation port 310 can be used for guiding an electrical charge to person 82 via electrodes 304, 308. The electrical charge may be stored in defibrillator 300, as discussed below.

If defibrillator 300 is a defibrillator-monitor, as was described with reference to FIG. 2, it will frequently also have an ECG port 319 in housing 301, for plugging in ECG lead wires 309. ECG lead wires 309 can sense an ECG signal, such as any of the ECG lead signals that comprise a common 12-lead ECG recording. Other types of ECG lead signals are equally applicable. A defibrillator-monitor could have additional ports that are not shown.

Defibrillator 300 also includes a measurement circuit 320. Measurement circuit 320 receives physiological signals from ECG port 319, and also from other ports, if provided. These physiological signals are sensed, and information about them is rendered by measurement circuit 320 as data, or other signals, etc.

Defibrillator 300 also includes a processor 330, which may be implemented in any number of ways. Such ways include, by way of example and not of limitation, digital and/or analog processors such as microprocessors and digital-signal processors (DSPs); controllers such as microcontrollers; software running in a machine; programmable circuits such as Field Programmable Gate Arrays (FPGAs), Field-Programmable Analog Arrays (FPAAs), Programmable Logic Devices (PLDs), Application Specific Integrated Circuits (ASICs), any combination of one or more of these, and so on.

Processor 330 can be considered to have a number of modules. One such module can be a detection module 332, which senses outputs of measurement circuit 320. Detection module 332 can include a VF detector. Thus, the person's sensed ECG can be used to determine whether the person is experiencing VF.

Another such module in processor 330 can be an advice module 334, which arrives at advice based on outputs of detection module 332. Advice module 334 can include a Shock Advisory Algorithm, implement decision rules, and so on. The advice can be to shock, to not shock, to administer other forms of therapy, and so on. If the advice is to shock, some external defibrillator embodiments merely report that to the user, and prompt them to do it. Other embodiments further execute the advice, by administering the shock. If the advice is to administer CPR, defibrillator 300 may further issue prompts for it, and so on. Processor 330 can include additional modules, such as module 336, for other functions too numerous to list here.

Defibrillator 300 optionally further includes a memory 338, which can work together with processor 330. Memory 338 may be implemented in any number of ways. Such ways include, by way of example and not of limitation, nonvolatile memories (NVM), read-only memories (ROM), random access memories (RAM), any combination of these, and so on. Memory 338, if provided, can include programs for processor 330, and so on. In addition, memory 338 can store prompts for the user, etc. Moreover, memory 338 can store patient data, such as, for example, data regarding the medical treatment provided to the patient during the incident, such as the occurrence and timing of defibrillation shocks and other information collected during the incident.

Defibrillator 300 may also include a power source 340. To enable portability of defibrillator 300, power source 340 typically includes a battery. Such a battery is typically implemented as a battery pack, which can be rechargeable or not. Sometimes, a combination of rechargeable and non-rechargeable battery packs is used. Other embodiments of power source 340 can include AC power override, for where AC power will be available, and so on. In some embodiments, power source 340 is controlled by processor 330.

Defibrillator 300 additionally includes an energy storage module 350. Module 350 is where some electrical energy is stored, when preparing it for sudden discharge to administer a shock. Module 350 can be charged from power source 340 to the right amount of energy, as controlled by processor 330. In typical implementations, module 350 includes one or more capacitors 352, or the like.

Defibrillator 300 moreover includes a discharge circuit 355. Discharge circuit 355 can be controlled to permit the energy stored in module 350 to be discharged to nodes 314, 318, and thus also to defibrillation electrodes 304, 308. Discharge circuit 355 can include one or more switches 357. Those can be made in a number of ways, such as by an H-bridge, or the like.

Defibrillator 300 further includes a user interface 370. User interface 370 can be made in any number of ways. For example, interface 370 may include a screen, to display what is detected and measured, provide visual feedback to a rescuer for their resuscitation attempts, and so on. User interface 370 may also include a speaker to issue audible signals, such as voice prompts, or the like. The user interface 370 may issue prompts to the user, visually or audibly, so that the user can administer CPR, for example. Interface 370 may additionally include various controls, such as pushbuttons, keyboards, touch screens, and so on. In addition, discharge circuit 355 can be controlled by processor 330, or directly by user via user interface 370, and so on.

Defibrillator 300 can optionally include other components. For example, a communication module 390 may be provided for communicating with other machines. Such communication can be performed wirelessly, or via wire, or by infrared communication, and so on. This way, data can be communicated, such as patient data, incident information, therapy attempted, CPR performance, and so on.

Specific Embodiments of a Network Platform for Annotating Recorded Medical Information

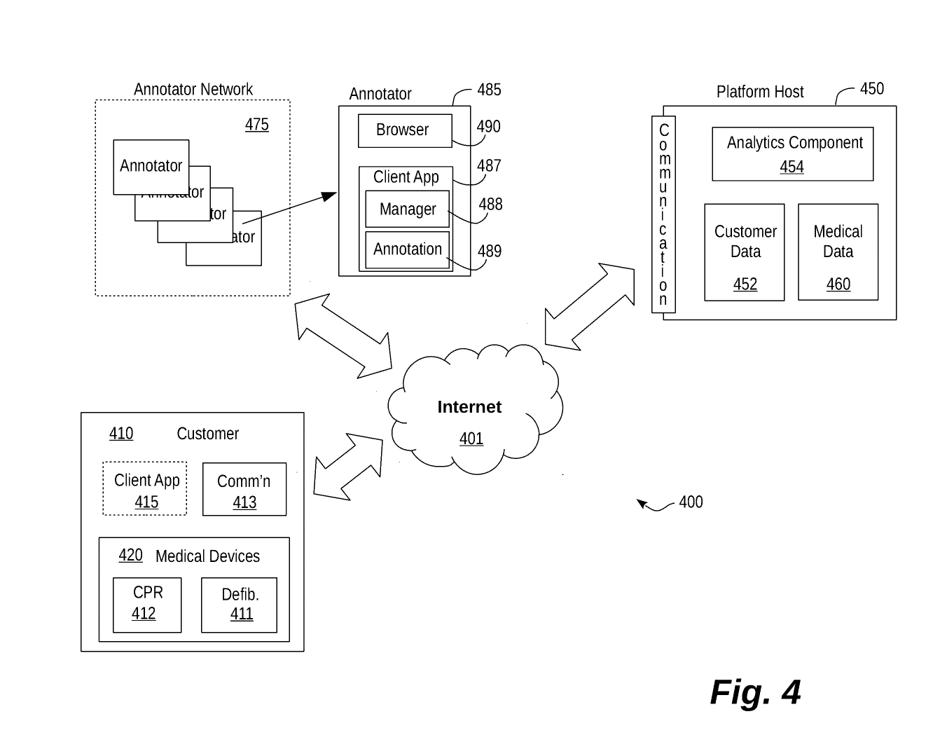

FIG. 4 is a functional block diagram generally illustrating one embodiment of a network platform 400 for annotating recorded medical information. The platform shown in FIG. 4 and described here sets out preferences and concepts to enable those skilled in the art to implement the teachings of this disclosure. Described here are only the preferred embodiments, and many other embodiments will be apparent from a careful review of this disclosure.

In short, the network platform 400 includes one or more customers, such as customer 410, and a platform host 450. The customer 410 is connected to the platform host 450 over a wide area network 401, such as the Internet. The customer 410 may be any user of medical devices, such as portable or standard defibrillators, mechanical compression devices, or any other devices used to provide medical treatment. In one example, customer 410 is a hospital that includes several defibrillators and other medical devices. The portable defibrillator described above is one preferred example of medical devices that customer 410 may use.

In this embodiment, the customer 410 may also include a communication component 413 that provides electronic connectivity between one or more facilities or devices at the customer 410 and external systems. In one example, the communication component 413 enables network connectivity among the medical devices and a client application (client app 415), and between the customer 410 and the wide area network 401. In particular, the communication component 413 enables network connectivity between the customer 410 (and its constituent devices) and the platform host 450.

The client app 415 is an optional component that may be installed at the customer 410 and is used to manage and administer at least some of the medical devices 420. As discussed below, the client app 415 may further enable a user to administer customer data which may be stored at the platform host 450 in association with the customer 410.

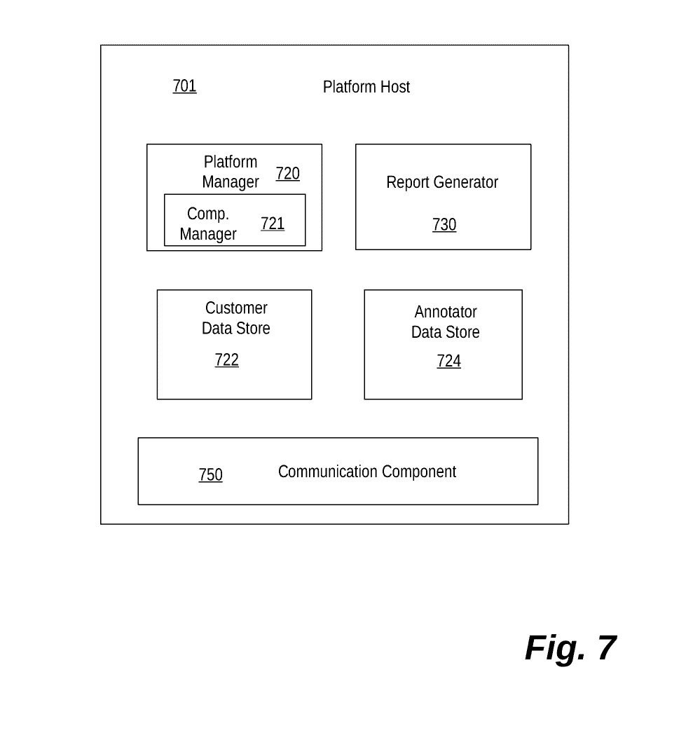

The platform host 450 of this particular embodiment is a facility used to administer data in association with or on behalf of customers, such as customer 410. The platform host 450 includes a communication component to enable network connectivity between the platform host 450 and other systems over the wide area network 401. One specific implementation of a preferred platform host is illustrated in FIG. 7 and described below. Very generally stated, the platform host 450 maintains customer data 452 that identifies each of several customers that use certain medical devices. For example, defibrillators 411 of the customer 410 may have corresponding account information hosted by the platform host 450. The platform host 450 further includes an administration and analytics component 454 that provides remote access to the customer data 452, and optionally to medical data 460. One example of the administration and analytics component is the LIFENET™ System product provided by Physio-Control, Inc.

In one specific implementation, the platform host 450 enables customer 410 to remotely administer customer data 452. In addition, for medical devices so configured, medical data may be transmitted from the medical devices 420, such as a portable defibrillator 411, to the platform host 450. The medical data 460 may include performance data collected by the medical devices during a medical incident. For instance, a defibrillator, such as defibrillator 411, may be used during a medical emergency to treat a patient suffering from a cardiac event. Medical data may be collected by that defibrillator during the treatment. That collected medical data may be transmitted to the client app 415 for analysis and reporting. Alternatively, that medical data may be transmitted to the platform host 450 over the wide area network 401 for remote analysis.

In this particular embodiment, that raw medical data may be analyzed to identify characteristics of the medical data that may be used to evaluate the medical treatment. For instance, as described above, the defibrillator 411 may be configured to record many events that occur during the medical treatment. Examples of the events include compressions performed while providing CPR, the delivery of a defibrillation shock, and the like. The client app 415 may be configured to analyze the raw medical data (e.g., ECG waveforms and the like) provided by the medical device and attempt to discern (or “guess”) at the several steps of the medical treatment provided to the patient. One specific example of a product that may be used as the client app 415 is the Code-Stat software product available from Physio-Control, Inc. of Redmond, Wash. Those skilled in the art will appreciate that the client app 415 may be used to create an after-action report on the quality and effectiveness of the medical treatment.

However, because the client app 415 may perform an imperfect analysis (as do most, if not all, automated devices), the client app 415 also includes a facility that allows for human review and modification. In one real-world example, the Code-Stat software provided by Physio-Control, Inc. allows customers to provide “annotations” to Code-Stat reports for event review. The annotated reports can be used to establish a baseline of emergency care performance, and to provide feedback for performance during particular events. The Code-Stat software automatically provides “markers” for certain detected actions (e.g., CPR compressions) using an algorithmic analysis. Although Code-Stat is very accurate in providing those markers, due to the complexity of the data and in some cases noisy environments during data collection, there can be marker errors. The marker errors are corrected during an annotation process supported by the Code Stat software. The annotations are typically entered by medical personnel trained to use the Code-Stat software and to recognize in the data the occurrence of the actions indicated by markers.

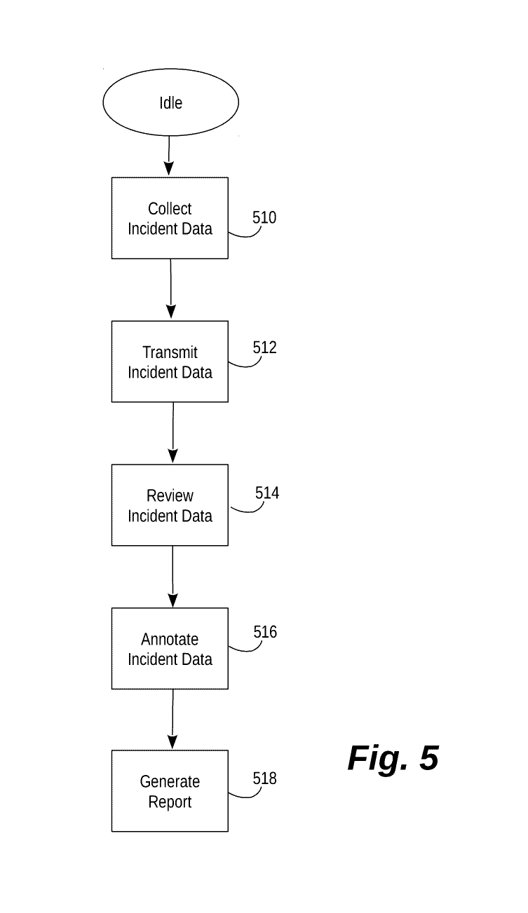

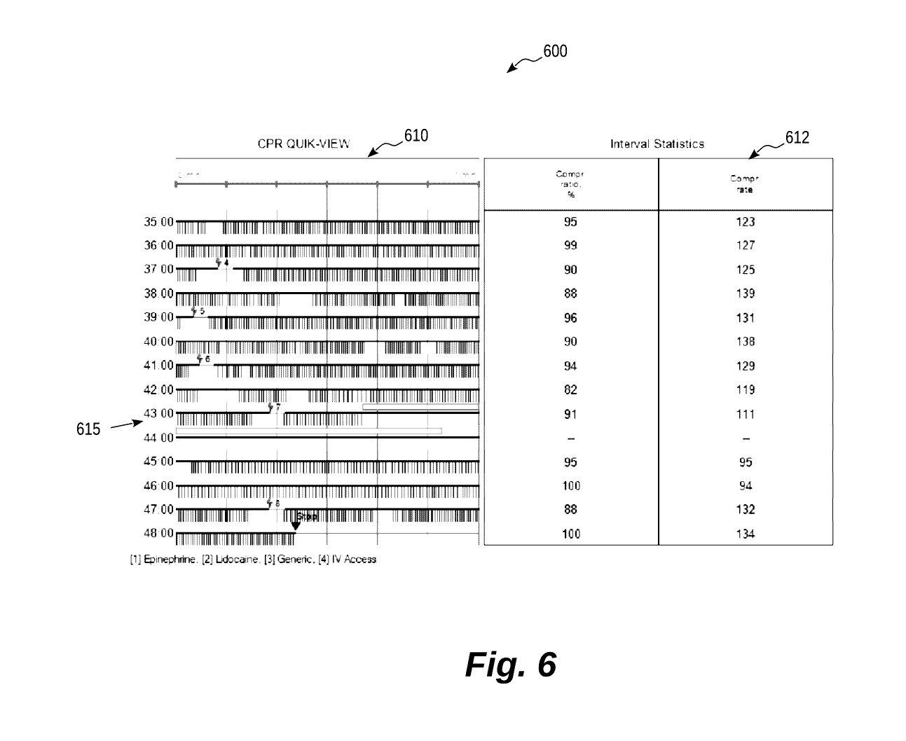

Referring to FIGS. 5 and 6, examples are shown and described to help illustrate one particular embodiment of the disclosure. Turning first to FIG. 5, a flow diagram generally illustrates operations performed by a medical data evaluation system such as may be used in certain embodiments. As illustrated, the operations include first collecting incident data (step 510), such as by recording data during a medical incident requiring medical treatment. Examples of such data include ECG waveforms and other data measured or detected by a medical device, such as a portable defibrillator, attached to a patient during treatment.

The incident data is transmitted (step 512) to an analysis facility, such as a client application or platform host. That analysis facility performs an automated review (step 514) of the transmitted incident data. The automated review may involve performing an algorithmic analysis of the incident data to identify certain events, such as delivering a chest compression or defibrillation shock, that occurred during the treatment. The algorithmic analysis generates an incident report based on the raw incident data.

Trained medical personnel review the incident report to further refine and in some circumstances correct the report (step 516). The process of refining and correcting the incident report may be referred to by those skilled in the art as “annotating” the incident report. Annotation improves the accuracy of the incident report and provides a customer with greater confidence that statistics derived from the incident data truly reflects the effectiveness and propriety of any treatment that was provided during the treatment.

Turning now briefly to FIG. 6, annotating an incident report is explained with reference to an illustration of one example. Shown in FIG. 6 is a sample screen display 600 of an incident report, such as may be generated by a client application (e.g., client app 415). In one specific implementation, the incident report shown in screen display 600 may be created by the Code-Stat software product from Physio-Control, Inc. The left portion of the screen display 600 illustrates the occurrence of several events 610 detected from raw incident data collected from a medical device, such as a defibrillator, used during medical treatment. As illustrated, the several events 610 include downward marks representing compressions performed during CPR, icons that represent shocks delivered by a defibrillator, and other data.

The right portion of the screen display represents statistics 612 derived from the several events 610. For example, the number of compressions per minute may be derived from the event data and displayed as a compression rate. During the 39th minute of treatment, for instance, the compression rate was approximately 131 compressions per minute. However, as is visible in the screen display 600, compressions ceased during the 43d minute of treatment 615 shortly after a defibrillation shock was delivered. One problem with machine analysis is that it can detect that compressions ceased, but it is difficult to determine programmatically why the compressions ceased. Accordingly, the statistical data 612 may be skewed or inaccurate because, for example, compressions may have stopped for a valid reason (such as return of spontaneous circulation or ROSC) which can be detected by a trained human reviewing the data but is exceedingly difficult for an automated process. For that reason, and others, a trained annotator can add annotations to the report to improve the report. For instance. the annotator can improve the report, such as by adding the start and stop of a cardiac arrest, deletion of false compression markers, addition of missed compression markers, start of ROSC, etc. The annotated reports more accurately reflect the performance of the emergency treatment. Accordingly, annotating incident reports greatly improves their accuracy and assists in collecting more accurate performance statistics.

Returning now to FIG. 4, an annotator network 475 is also shown in the network platform 400. The annotator network 475 is provided to address certain undesirable circumstances that the inventors have identified. More specifically, some customers, such as customer 410, do not have sufficient resources to staff and train annotators, or do not have enough annotators on-call to provide rapid feedback when cardiac events occur. For example, the inventors have determined that rapid feedback on the quality of the emergency care (e.g., CPR) greatly enhances the improvement to the team providing the care. In short, providing feedback on the quality of treatment very promptly after that treatment was provided is much more effective at remedying any deficiencies.

The network platform addresses those concerns by providing the annotator network of trained and certified annotators who are available to remotely review and annotate incident reports, thereby relieving the customer 410 of the need for dedicated annotators. and implementing a system that allows a customer to rapidly assign the annotation of an incident report to one of the annotators in the annotator network 475. In this embodiment, the platform host 450 provides a portal for customers to request a remote annotation of an incident report. In one embodiment, each of the annotators (e.g., annotator 485) in the annotator network 475 may include an annotator client application (client app 487) that is configured to receive, over the wide area network 401, requests for annotating incident reports, and allows the annotator 485 to respond to that request. The annotator may execute the client app 487 on a portable device, such as a tablet, or a desktop computer. In some implementations, the client app 487 also sends an availability status to the platform host 450 to notify the platform host 450 that the annotator is available at that time to accept requests for annotations.

In one embodiment, customers (such as customer 410) are provided with a customer client app 415 that allows the customer 410 to upload incident reports to the platform host 450 for remote annotation. The customer client app 415 can be loaded in the customer's local system, such as a hospital's medical device administration system (e.g., the LIFENET system from Physio-Control, Inc.), directly in a medical device 420 (e.g., a LIFEPAK monitor/defibrillator), or other suitable connected device. In one embodiment, the platform host 450 may validate the customer 410 and confirm that the uploaded incident report is proper. If so, the platform host 450 sends the request for annotation to the annotator network 475 for annotation. In one embodiment, the request is assigned to the first annotator to respond, and the incident report is transmitted to the responding annotator (e.g., annotator 485).

Each annotator in the annotator network may include an annotator client application (e.g., client app 487). The annotator may also or alternatively include a network communication component, such as browser software 490 or the like. In one embodiment, the client app 487 includes an annotator manager component 488 and an annotation component 489. The annotator manager component 488 is configured to administer the annotator's account, such as to register as available with the platform host 450, to accept requests for annotation, to administer any compensation for the benefit of the annotator, to communicate with other annotators in the annotator network 475, to communicate with the requesting customer 410, and the like.

The annotation component 489 may also reside on the annotator 485 and provide similar functionality to the customer client app 415 regarding the annotation of incident reports. In short, the annotation component 489 enables a user, possessing the appropriate skills and training, to review an incident report and annotate that incident report as appropriate. In an alternative embodiment, the annotator 485 may perform the annotation service using only the browser software 490. For example, and as described below, the platform host 450 may expose a remotely-accessible service to enable remote annotations over the wide area network 401 without requiring the installation of client-installed software.

In this embodiment, the platform host 450 further includes infrastructure for associating customers with one or more annotators in the annotator network 475. One embodiment of an illustrative platform host is shown in FIG. 7 and described below. Generally stated, the platform host 450 is configured to receive annotation requests from customers, and to provide those annotation requests to available annotators in the annotation network. The platform host 450 is further configured to administer compensation for the annotators performing the service.

Turning now to FIG. 7, one embodiment of a platform host 701 is shown. In this embodiment, and generally stated, the platform host 701 may provide, in a HIPAA compliant manner, (a) incident reports to annotators; (b) annotated incident reports back to customers; (c) billing of the customers as appropriate; (d) payment to the annotators as appropriate; and (e) tracking/reporting of assignments, payments, billings, and annotator performance metrics.

As shown in FIG. 7, the platform host 701 includes a platform manager 720, which is a functional component that includes logic to manage each of the other components of the platform host 701 and to administer the assignment of annotation requests from customers to annotators. In addition, the the platform host 701 further includes a customer data store 722 and an annotator data store 724. The customer data store 722 includes information about each customer that is making use of the annotator network. The customer data store 722 includes both transient customer data (e.g., current annotation requests, unfulfilled requests, number of requests, outstanding compensation data, and the like) and persistent customer data (e.g., name and location of the customer, number and type of devices maintained by the customer, incident report history, and the like). The annotator data store 724 includes information about each annotator in the annotator network. The annotator data store 724 includes both transient annotator data (e.g., current availability of the annotator, currently assigned requests, outstanding annotations, and the like) and persistent annotator data (e.g., name and location of the annotator, training and skills of the annotator, compensation status and information, annotation quality data, annotation history data, and the like). The customer data store 722 and the annotator data store 724 may be used by the platform host 701 to intelligently assign requests by customers to annotators.

The platform manager 720 also includes a compensation manager 721 that is configured to manage and implement compensation for the annotators. In some embodiments, uniform fees may be set to pay annotators for annotating incident reports. The uniform fee may a single fixed fee that applies to all annotators. Alternatively, the compensation may be a variable fee based on feedback from customers about annotations (e.g., quality, responsiveness, etc.) performed by annotators. In still other embodiments, the compensation may vary, depending on the size of the incident report, the service level of the request (e.g., normal, rush, low priority), the level of training or certification of the annotator, etc. The compensation manager 721 may also be configured to manage fees charged to customers, and to track charges and payments (account activity) made by the customer.

The compensation manager 721 may also provide mechanisms to allow an annotator to provide promotional codes for discounts, a time expected to complete the annotations; and/or a fee schedule for various types of requests, such as rush jobs, or fees based on the size of the Code-State reports, or the time of day (e.g., a Request submitted in at 2 am may be more expensive than one submitted at 10 am). Customers can then use this information to help select which annotator to send a Request.

In still other embodiments, the compensation manager 721 may be configured to enable customers to enter promotional codes that would be reflected in the account activity, that are then communicated to the platform manager 720. The compensation manager 721 may also provide account activity to the customer for display, for example using the customer client app 415. Similarly, the compensation manager 721 may track account activity for annotators to be displayed using the annotator client app 487.

In yet another embodiment, compensation to the annotators may take several forms. For example, in certain cases, annotators may be precluded from accepting financial compensation for performing annotations. In one specific example, perhaps one or more annotators are employed by a customer that performs relatively-few annotations. In such an instance, annotators or their employers may desire for the annotators to maintain their skills by performing additional annotations. In that instance, the employer may contract annotators to the annotator network in exchange for either financial compensation to the employer or directly to the annotator. But the compensation may also be provided in non-monetary form, such as credits to the employer for other services or products, such as additional medical devices.

In some embodiments, the platform host 701 may receive instructions from the customer for particular annotation requests. For example, through the customer client app 415, the customer 410 may specify a service level for the request, a desired experience level of the annotators, etc. The platform manager 720 may then send the request only to annotators that satisfy the service level set by the customer. In a further refinement, if the incident report is “localized” for a particular country, region or language, the platform manager 720 may be configured to only send the request to annotators capable of handling that particular “localization.”

In other embodiments, the platform manager 720 may provide the customer with a list of available annotators so that the customer can select from the available annotators. In a further refinement, customers may provide ratings of particular annotators, and the list of available annotators may also include each available annotator's rating. The platform manager 720 may provide other types of data for the annotators as well, such as the number of annotations completed by the annotator, the number of times the customer has used a particular annotator, the number of times a report had to be sent back to the annotator to correct annotations, the location of the available annotators (which can be based on the location as provided by the annotator client app), etc.

In one embodiment, the platform host 701 further includes a report generator 730 that is configured to generate reports on the performance of the annotator network, or the quality of the annotations, or both. For instance, the report generator 730 may review and aggregate data from the customer data store 722 and the annotator data store 724 pertaining to the quality of the medical treatment being provided by various medical personnel. Such reports may be aggregated either for a single customer or set of customers, for all the customers globally, for a single annotator or set of annotators, for all the annotators globally, or any combination of those data sets.

In one example, for instance, aggregate annotated reports may be used to evaluate (either in the aggregate or in any subset) the quality of the treatment is provided by the various medical personnel. The aggregate data may be used to compare the apparent quality of the medial treatment to accepted standards. For example, the aggregate apparent quality of the medical treatment actually provided may be compared to individual guidelines, which may be provided by the various customers, or general guidelines, such as those provided by the American Heart Association.

In yet another embodiment, the platform host 701 may implement a communication component 750, such as a web server or the like. The communication component 750 may be used to expose functionality of each of the other components over a wide are network, such as the Internet. In such an embodiment, customers, annotators, or both may use the communication component 750 to interact with each of the other components of the platform host 701 remotely. In this way, the platform host 701 may expose the annotator network functionality as a web service or hosted service, thereby ameliorating any need for local software installed either at the customer location or at the annotator location.

Other embodiments may include combinations and sub-combinations of features described or shown in FIGS. 3-7, including for example, embodiments that are equivalent to providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, “feature” or “features” can refer to structures and/or functions of an apparatus, article of manufacture or system, and/or the steps, acts, or modalities of a method.

In the foregoing description, numerous details have been set forth in order to provide a sufficient understanding of the described embodiments. In other instances, well-known features have been omitted or simplified to not unnecessarily obscure the description.

A person skilled in the art in view of this description will be able to practice the disclosed invention. The specific embodiments disclosed and illustrated herein are not to be considered in a limiting sense. Indeed, it should be readily apparent to those skilled in the art that what is described herein may be modified in numerous ways. Such ways can include equivalents to what is described herein. In addition, the invention may be practiced in combination with other systems. The following claims define certain combinations and subcombinations of elements, features, steps, and/or functions, which are regarded as novel and non-obvious. Additional claims for other combinations and subcombinations may be presented in this or a related document.

What is claimed is:

1. An annotator platform, comprising:
a network of customers, each customer comprising one or more medical devices, each medical device being configured to collect performance data about medical treatment provided to a patient during a medical incident, at least one customer being further configured to communicate with other systems over a wide area network, the customer being still further configured to transmit, over the wide area network, a request for annotation of the performance data;
a network of annotators in operative connection to the wide area network, each annotator comprising a client application operative to facilitate communication over the wide area network and an annotator client application, the annotator client application operative to enable annotation of an incident report; and
a platform host configured to dispatch the request for annotation to an available annotator in the network of annotators, the available annotator being identified based at least in part on information maintained by the platform host identifying a status for each annotator in the network of annotators, the platform host being further configured to return an annotated incident report to the customer.

2. The annotator platform recited in claim 1, wherein the platform host is configured to expose functionality over the wide area network to enable the customer to submit the request for annotation remotely, or to enable the available annotator to perform the annotation service remotely, or to enable both the customer and the available annotator to interact with each other.

3. A method for providing annotations, comprising:
receiving an annotation request for an annotation from a customer, the annotation request being associated with an incident report;
identifying an appropriate annotator from a listing of available annotators;
assigning the annotation request to the appropriate annotator;
returning an annotated incident report to the customer; and
maintaining compensation information related to the annotated incident report.

4. The method recited in claim 3, wherein the compensation is non-monetary.
